(19) United States
(12) Patent Application Publication
(10) Pub. No.: US 2026/0002815 A1
(43) Pub. Date: Jan. 1, 2026

(54) METHOD FOR PREPARING SUPPORTING SPRING MODEL AND INTEGRATED INTERFEROMETER DEVICE

(71) Applicant: Harbin Institute of Technology, Shenzhen (Shenzhen Institute of Science and Technology Innovation, H, Guangdong (CN)

(72) Inventors: Gaopeng XUE, Guangdong (CN); Honglin QIAN, Guangdong (CN); Bing LI, Guangdong (CN)

(73) Assignee: Harbin Institute of Technology, Shenzhen (Shenzhen Institute of Science and Technology Innovation, H, Guangdong (CN)

(21) Appl. No.: 18/901,235

(22) Filed: Sep. 30, 2024

(30) Foreign Application Priority Data
Jun. 26, 2024 (CN) 202410843993.2

(51) Int. Cl. G01J 3/02; G01J 3/26

(52) U.S. Cl. CPC G01J 3/0259; G01J 3/0202; G01J 3/021; G01J 3/26

(57) ABSTRACT

A method for preparing a supporting spring model and an integrated interferometer device are provided, which relates to the technical field of infrared spectrometers. The method includes the following steps: multiple groups of initial control point coordinate sequences, which are determined based on a second-order Bezier curve and are configured to simulate control point coordinates of a supporting spring model, are iterated by using a genetic algorithm; and a supporting spring model for preparing a supporting spring structure in an integrated interferometer device is determined. The supporting spring model are simulated and iterated, so as to improve an optical path difference of the integrated interferometer device and further improve a resolution of the infrared spectrometer. The interferometer device includes a component layer, a buried oxide layer and a substrate layer. Reflectors are integrated with the substrate layer without installing the reflectors additionally.

### CROSS-REFERENCE TO RELATED APPLICATION

This patent application claims the benefit and priority of Chinese Patent Application No. 2024108439932 filed with the China National Intellectual Property Administration on Jun. 26, 2024, the disclosure of which is incorporated by reference herein in its entirety as part of the present application.

### TECHNICAL FIELD

The present disclosure relates to the technical field of infrared spectrometers, in particular to a method for preparing a supporting spring model and an integrated interferometer device.

### BACKGROUND

Spectral analysis has always played an important role in the field of modern industrial production and scientific research, which is widely used in the fields such as semiconductor industry, composition analysis, environmental monitoring. As the core of spectral analysis, infrared spectrometers with a high sensitivity have been achieved, but there are some problems such as a high cost and a lack of portability. Therefore, miniaturization is an important research direction of infrared spectrometers at present. Micro-Electro-Mechanical System (MEMS)-based technology is an important means to realize the miniaturization of infrared spectrometers.

Infrared spectrometers are generally classified into dispersive infrared spectrometers and interferometric infrared spectrometers. The dispersive infrared spectrometers have some disadvantages, such as a low luminous flux, a large energy loss of light source and a slow data acquisition speed. The interferometric infrared spectrometers are based on the principle of Fourier transform of the interfered infrared light, also referred to as Fourier Transform Infrared Spectrometers (FTIR Spectrometers). Compared with the dispersive infrared spectrometer, the Fourier transform infrared spectrometer has the advantages of a high resolution, a high wave number precision, a fast scanning speed and a high sensitivity. Therefore, the Fourier infrared spectrometer is the focus of the current research for the spectrometer.

At present, for the Fourier infrared spectrometer, the smaller the optical path difference formed by the interferometer in the spectrometer, the lower the resolution of the infrared spectrometer, and the lower the accuracy of further acquired spectral information. However, the supporting spring in the interferometer is the biggest factor limiting the optical path difference of the interferometer, the existing wishbone interferometer relies on a serpentine supporting spring in the traditional MEMS driver, such supporting spring is suitable for the displacement of the traditional driver in the x and y orthogonal directions, rather than suitable for rotation driving, resulting in a small displacement angle that can be driven and a small optical path difference of the reflector. In addition, it is difficult to install the reflector. The surface of the installed reflector is not vertical, so that the reflected light is not parallel to the incident light, resulting in low resolution of the infrared spectrometer. Therefore, in the infrared spectrometer in the prior art, the optical path difference formed by the interferometer is small, so as to result in a low resolution of the infrared spectrometer and further lead to a low analysis precision of a material structure and a material composition.

### SUMMARY

The purpose of the present disclosure is to provide a method for preparing a supporting spring model and an integrated interferometer device, so as to solve the problems in the prior art that the optical path difference formed by the interferometer in the infrared spectrometer is small, so as to result in a low resolution of the infrared spectrometer and further lead to a low analysis precision of a material structure and a material composition, and that it is difficult to install a reflector.

In order to achieve the above purpose, the present disclosure provides the following solution.

A method for preparing a supporting spring model, including:
determining a first control point coordinate of a second-order Bezier curve for simulating a supporting spring model based on the second-order Bezier curve in a mathematical modeling software installed in a computer;
randomly creating 4n groups of initial control point coordinate sequences of the second-order Bezier curve for simulating the supporting spring model in a modelable area of the supporting spring model based on the second-order Bezier curve; the initial control point coordinate sequences each include a second control point abscissa of the second-order Bezier curve, a second control point ordinate of the second-order Bezier curve, a third control point abscissa of the second-order Bezier curve and a third control point ordinate of the second-order Bezier curve; 4n is a number of the initial control point coordinate sequences, and n is a positive number greater than or equal to 1;
iterating the 4n groups of initial control point coordinate sequences by using a genetic algorithm, and creating 4n groups of target control point coordinate sequences when a target number of iterations is reached;
determining the supporting spring model according to the first control point coordinate and the 4n groups of target control point coordinate sequences;
preparing a supporting spring structure in an integrated interferometer device according to the supporting spring model.

Preferably, iterating the 4n groups of initial control point coordinate sequences by using a genetic algorithm, and creating 4n groups of target control point coordinate sequences when a target number of iterations is reached, specifically includes:
iterating the 4n groups of initial control point coordinate sequences by using the genetic algorithm, and creating the 4n groups of target control point coordinate sequences when the target number of the iterations is reached;
each of the iterations includes:

determining a current supporting spring model according to the first control point coordinate and 4n groups of current control point coordinate sequences;
carrying out finite element simulation on an integrated interferometer model corresponding to the current supporting spring model to determine rotation angles of 4n groups of reflectors; the rotation angles of the reflectors are rotation angles of reflectors of the integrated interferometer model corresponding to the current supporting spring; the integrated interferometer model is configured to prepare the integrated interferometer device;
determining 4n groups of control point coordinate sequences for next iteration based on the rotation angles of the 4n groups of reflectors.

Preferably, subsequent to carrying out finite element simulation on an integrated interferometer model corresponding to the current supporting spring model to determine rotation angles of 4n groups of reflectors, the method specifically includes:
determining an optical path difference of the integrated interferometer model according to the rotation angles of the 4n groups of reflectors.

Preferably, determining an optical path difference of the integrated interferometer model according to the rotation angles of the 4n groups of reflectors specifically includes:
determining a first optical path difference of the integrated interferometer model according to clockwise rotation angles of the 4n groups of reflectors;
determining a second optical path difference of the integrated interferometer model according to counterclockwise rotation angles of the 4n groups of reflectors;
determining the optical path difference of the integrated interferometer model according to the first optical path difference and the second optical path difference.

Preferably, subsequent to determining an optical path difference of the integrated interferometer model according to the rotation angles of the 4n groups of reflectors, the method specifically includes:
determining whether the target number of the iterations is reached according to the optical path difference of the integrated interferometer model;
determining that the target number of the iterations is reached when the optical path difference of the integrated interferometer model is greater than or equal to a preset optical path difference;
determining that the target number of the iterations is not reached when the optical path difference of the integrated interferometer model is less than the preset optical path difference.

An integrated interferometer device, including a component layer, a buried oxide layer and a substrate layer;
the component layer includes multiple driving comb movable parts, multiple driving comb fixing parts, multiple sensing comb movable parts, multiple sensing comb fixing parts, multiple supporting spring structures and a fixing outer frame; each of the supporting spring structures is prepared by the method for preparing the supporting spring model; the component layer has a bridge structure; the component layer is configured to be connected with the substrate layer;
the substrate layer includes a reflector structure and a balance weight structure;
the buried oxide layer is arranged between the component layer and the substrate layer for electrical insulation between the component layer and the substrate layer;
an end of each of the multiple driving comb movable parts, an end of each of the multiple sensing comb movable parts and an end of each of the multiple supporting spring structures are all connected to a center of movable parts of the component layer;
the multiple driving comb fixing parts and the multiple driving comb movable parts are arranged in one-to-one correspondence; the multiple sensing comb fixing parts and the multiple sensing comb movable parts are arranged in one-to-one correspondence; the multiple driving comb fixing parts and the multiple sensing comb fixing parts are integrated with the fixing outer frame;
the reflector structure includes a first reflector structure and a second reflector structure; the first reflector structure is connected to the center of the movable parts of the component layer; the second reflector structure is connected to the center of the movable parts of the component layer; the first reflector structure and the second reflector structure form an angle of 90 degrees and are both configured to reflect received light; the reflector structure is integrated with the substrate layer; and the reflector structure is a corner cube;
the balance weight structure includes a first balance weight structure and a second balance weight structure; the first balance weight structure and the second balance weight structure are both connected with the center of the movable parts of the component layer; the first balance weight structure is configured to balance the first reflector structure; the second balance weight structure is configured to balance the second reflector structure;
an end of each of the multiple supporting spring structures is connected to the center of the movable parts of the component layer; an other end of each of the multiple supporting spring structures is connected to the fixing outer frame; the multiple supporting spring structures are configured to provide supporting moments for the multiple driving comb movable parts, the multiple sensing comb movable parts and the reflector structure;
the driving comb movable parts and the driving comb fixing parts are configured to drive the reflector structure to move through a sensing driving electric signal;
the sensing comb movable parts and the sensing comb fixing parts are configured to detect capacitance signals used for calculating an optical path difference; and the capacitance signals are output from electrodes corresponding to the sensing comb fixing parts.

Preferably, a mirror surface of the reflector structure is prepared by depositing a reflecting layer material by using a hard mask.

Preferably, the driving comb movable parts, the driving comb fixing parts, the sensing comb movable parts and the sensing comb fixing parts are made by using a deep silicon etching process and by etching the substrate layer at back.

Preferably, the component layer further includes: an electrical interconnection system;
the electrical interconnection system is configured to be connected to an external circuit, and receive and output a driving electric signal transmitted by the external circuit.

Preferably, the component layer further includes driving electrodes, multiple grounding electrodes and multiple sensing electrodes;
the driving electrodes include one clockwise driving electrode and four counterclockwise driving electrodes;
the clockwise driving electrode is connected with the electrical interconnection system and the driving comb fixing parts, respectively, and is configured to receive the driving electric signal transmitted by the electrical interconnection system and transmit the driving electric signal to the driving comb fixing parts to drive the driving comb movable parts to move clockwise;
the four counterclockwise driving electrodes are connected with the electrical interconnection system and the driving comb fixing parts, and are configured to receive the driving electric signal transmitted by the electrical interconnection system and transmit the driving electric signal to the driving comb fixing parts to drive the driving comb movable parts to move counterclockwise;
the multiple grounding electrodes are connected with the electrical interconnection system and the ground, and are configured to provide multiple paths to enable the driving comb movable parts and the driving comb fixing parts to be kept electrostatic induction;
the multiple sensing electrodes are connected with the electrical interconnection system and the sensing comb fixing parts, and are configured to extract the capacitance signals.

According to the specific embodiments provided by the present disclosure, the present disclosure discloses the following technical effects.

The present disclosure provides a method for preparing a supporting spring model, which includes the following steps: a first control point coordinate of a second-order Bezier curve for simulating a supporting spring model is determined based on the second-order Bezier curve; 4n groups of initial control point coordinate sequences of the second-order Bezier curve for simulating the supporting spring model are randomly created based on the second-order Bezier curve and according to the first control point coordinate; a genetic algorithm is used to iterate the 4n groups of initial control point coordinate sequences, and 4n groups of target control point coordinate sequences are created when the target number of iterations is reached; the supporting spring model is further determined according to the first control point coordinate and the 4n groups of target control point coordinate sequences; and a supporting spring structure in an integrated interferometer device is finally prepared according to the supporting spring model. According to the present disclosure, the supporting spring model of the supporting spring structure of the interferometer in the infrared spectrometer is simulated and iteratively optimized, so as to improve an optical path difference of the integrated interferometer device and a resolution of the infrared spectrometer. Therefore, the analysis precision of a material structure and a material composition from the infrared spectrometer can be further improved.

In addition, the present disclosure further provides an integrated interferometer device. The integrated interferometer device includes a component layer, a buried oxide layer and a substrate layer. The component layer includes supporting spring structures prepared by using the supporting spring model. Through the supporting spring structure, the optical path difference of the integrated interferometer device is improved, and the resolution of the infrared spectrometer and the analysis precision of the material structure and the material composition are improved. In addition, the integrated interferometer device uses an integrated design. The reflector is integrated with the substrate layer without being installed. The reflector is designed as a corner cube, thus solving the problem that the reflected light is not parallel to the incident light since the surface of the installed reflector is not vertical. Moreover, in order to facilitate the installation of the corner cube without affecting the optical path of the corner cube on the substrate layer, the integrated interferometer device has a concave design for the beam splitter. The component layer is integrally connected through a bridge structure, thus ensuring the robustness of the entire structure. Further, in order to prevent the substrate layer under the component layer from affecting the optical path, the corresponding area of the substrate layer structure is removed by etching, and the bridge structure and the component layer are used to connect the two separated parts of the substrate layer, thus avoiding the influence on the electrical interconnection and facilitating the transmission of electric signals through the component layer.

Furthermore, the rotating wishbone interferometer is used instead of the traditional Michelson interferometer, the optical path difference of the rotating wishbone interferometer is twice that of the Michelson interferometer, thus improving the spectral resolution.

### BRIEF DESCRIPTION OF THE DRAWINGS

In order to explain the technical solutions of the embodiments of the present disclosure or in the prior art more clearly, the drawings needed in the embodiments will be briefly introduced hereinafter. Apparently, the drawings in the following description are only some embodiments of the present disclosure. For those skilled in the art, other drawings can be obtained according to these drawings without creative labor.

FIG. 1 is a flowchart of a method for preparing a supporting spring model according to the present disclosure;

FIG. 2 is a structural diagram of an integrated interferometer device according to the present disclosure;

FIG. 3 is a rear view of the integrated interferometer device according to the present disclosure;

FIG. 4 is a working principle diagram of the integrated interferometer device according to the present disclosure;

FIG. 5 is a structural schematic diagram of a supporting spring model;

FIG. 6A is a structural diagram of a first iteration of the supporting spring model; FIG. 6B is a structural diagram of a second iteration of the supporting spring model; FIG. 6C is a structural diagram of a third iteration of the supporting spring model; FIG. 6D is a structural diagram of a fourth iteration of the supporting spring model; FIG. 6E is a structural diagram of a fifth iteration of the supporting spring model; FIG. 6F is a structural diagram of a sixth iteration of the supporting spring model;

FIG. 7A is a schematic diagram of depositing an Au/Cr electrode on a component layer by a lift-off process; FIG. 7B is a schematic diagram of depositing Au on a back through a hard mask; FIG. 7C is a schematic diagram of deep silicon etching a component layer by 80 μm; FIG. 7D is a schematic diagram of etching of an oxide layer by 1 μm; FIG. 7E is a schematic diagram of etching a substrate layer by 500 μm on the back;

FIG. 8 is an angular displacement sensing diagram when driving comb movable parts in the integrated interferometer device move clockwise;

FIG. 9 is an angular displacement sensing diagram when driving comb movable parts in the integrated interferometer device move counterclockwise; and

FIG. 10 is a structure diagram of gas detection of a Fourier infrared spectrometer including an integrated interferometer device.

### DESCRIPTION OF REFERENCE NUMBERS

1 Clockwise driving electrode, 2 first sensing electrode, 3 first part of a first sensing comb movable part, 4 first part of a first driving comb movable part, 5 first counterclockwise driving electrode, 6 first reflector structure, 7 second sensing electrode, 8 second part of a first driving comb movable part, 9 second part of a first sensing comb movable part, 10 first supporting spring structure, 11 first part of a second driving comb movable part, 12 second part of a second driving comb movable part, 13 second reflector structure, 14 second supporting spring structure, 15 second counterclockwise driving electrode, 16 first grounding electrode, 17 first part of a second sensing comb movable part, 18 third sensing electrode, 19 first part of a third driving comb movable part, 20 first balance weight structure, 21 third counterclockwise driving electrode, 22 second part of a third driving comb movable part, 23 fourth sensing electrode, 24 second part of a second sensing comb movable part, 25 third supporting spring structure, 26 second grounding electrode, 27 first part of a fourth driving comb movable part, 28 second part of a fourth driving comb movable part, 29 second balance weight structure, 30 fourth supporting spring structure, 31 fourth counterclockwise driving electrode, 32 third grounding electrode, 33 center of movable parts of a component layer, 34 beam splitter structure, 35 infrared detector, 36 infrared light source, 37 integrated interferometer device, 38 gas chamber, 39 PCB.

### DETAILED DESCRIPTION OF THE EMBODIMENTS

The technical solutions in the embodiments of the present disclosure will be clearly and completely described with reference to the drawings in the embodiments of the present disclosure hereinafter. Apparently, the described embodiments are only some embodiments of the present disclosure, rather than all of the embodiments. Based on the embodiments of the present disclosure, all other embodiments obtained by those skilled in the art without creative labor fall within the scope of protection of the present disclosure.

The present disclosure aims to provide a method for preparing a supporting spring model, aiming at simulating and iteratively optimizing the supporting spring model of the supporting spring structure of the interferometer in the infrared spectrometer, so as to improve an optical path difference of the integrated interferometer device and a resolution of the infrared spectrometer. Therefore, the analysis precision of a material structure and a material composition from the infrared spectrometer can be further improved.

In addition, the present disclosure further provides an integrated interferometer device, which includes a simulated supporting spring model. The optical path difference of the integrated interferometer device is improved, so as to improve the resolution of the infrared spectrometer and further improve the accuracy of the acquired spectral information. Moreover, the integrated interferometer device uses an integrated design, which solves the problem that the optical path deviation of the interferometer is large since it is difficult to install the beam splitter, and further improves the resolution of the infrared spectrometer.

In order to make the above purposes, features and advantages of the present disclosure more clear and understandable, the present disclosure will be explained in further detail with reference to the drawings and detailed description hereinafter.

### Embodiment 1

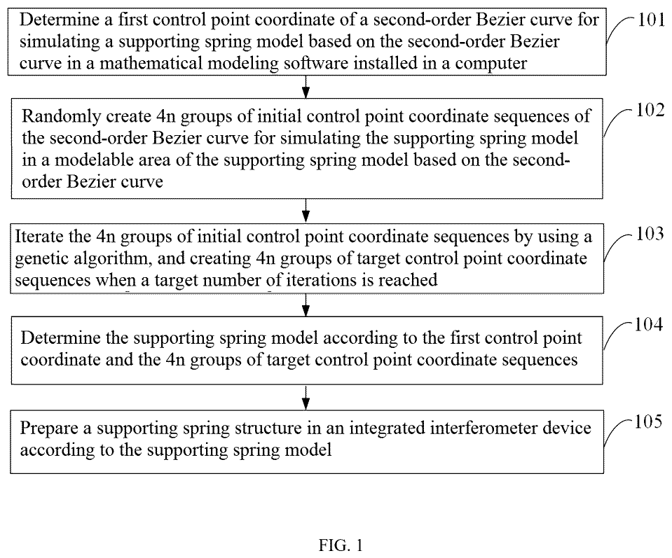

As shown in FIG. 1, the method for preparing the supporting spring model according to the present disclosure includes the following steps.

Step 101, a first control point coordinate of a second-order Bezier curve for simulating a supporting spring model is determined based on the second-order Bezier curve in a mathematical modeling software installed in a computer;

Step 102, 4n groups of initial control point coordinate sequences of the second-order Bezier curve for simulating the supporting spring model are randomly created in a modelable area of the supporting spring model based on the second-order Bezier curve; the initial control point coordinate sequences each include a second control point abscissa of the second-order Bezier curve, a second control point ordinate of the second-order Bezier curve, a third control point abscissa of the second-order Bezier curve and a third control point ordinate of the second-order Bezier curve; 4n is the number of the initial control point coordinate sequences, and n is a positive number greater than or equal to 1;

Step 103, a genetic algorithm is used to iterate the 4n groups of initial control point coordinate sequences, and 4n groups of target control point coordinate sequences are created when a target number of iterations is reached;

Step 104, the supporting spring model is determined according to the first control point coordinate and the 4n groups of target control point coordinate sequences;

Step 105, a supporting spring structure in an integrated interferometer device is prepared according to the supporting spring model.

Further, each iteration in step 103 includes: a current supporting spring model is determined according to the first control point coordinate and 4n groups of current control point coordinate sequences; finite element simulation is carried out on an integrated interferometer model corresponding to the current supporting spring model to determine rotation angles of 4n groups of reflectors; the rotation angles of the reflectors are the rotation angles of reflectors of the integrated interferometer model corresponding to the current supporting spring; the integrated interferometer model is configured to prepare the integrated interferometer device; 4n groups of control point coordinate sequences for the next iteration are determined based on the rotation angles of the 4n groups of reflectors.

Further, 4n groups of control point coordinate sequences for the next iteration are determined based on the rotation angles of the 4n groups of reflectors, which specifically includes: 2n groups of parents of next-generation control point coordinate sequences are determined based on the rotation angles of the 4n groups of reflectors; In groups of first daughters of next-generation control point coordinate sequences are determined according to the 2n groups of parents of next-generation control point coordinate sequences; In groups of second daughters of next-generation control point coordinate sequences are determined according to the 2n groups of parents of next-generation control point coordinate sequences; and 4n groups of control point coordinate sequences for the next iteration are determined according to the 2n groups of parents of next-generation control point coordinate sequences, the 1n groups of first daughters of next-generation control point coordinate sequences, and the 1n groups of second daughters of next-generation control point coordinate sequences.

Further, 2n groups of parents of next-generation control point coordinate sequences are determined based on the rotation angles of the 4n groups of reflectors, which specifically includes: the control point coordinate sequences corresponding to the rotation angles of the previous 2n groups of reflectors are selected as the parents of control point coordinate sequences for the next iteration according to a decreasing order of the displacement of the rotation angles of the 4n groups of reflectors based on the rotation angles of the 4n groups of reflectors.

Further, 1n groups of first daughters of next-generation control point coordinate sequences are determined according to the 2n groups of parents of next-generation control point coordinate sequences, which specifically includes: cross processing of the second control point abscissa and the third control point abscissa in the 2n groups of parents of next-generation control point coordinate sequences are carried out, and cross processing of the second control point ordinate and the third control point ordinate in the 2n groups of parents of next-generation control point coordinate sequences are carried out to determine the 1n groups of first daughters of next-generation control point coordinate sequences.

Further, 1n groups of second daughters of next-generation control point coordinate sequences are determined according to the 2n groups of parents of next-generation control point coordinate sequences, which specifically includes: the coordinate values of the second control point abscissa, the second control point ordinate, the third control point abscissa and the third control point ordinate of the 2n groups of parents of next-generation control point coordinate sequences are floated in a small range to determine the 1n groups of second daughters of next-generation control point coordinate sequences; floating in the small range refers to floating in the range of 0 μm-20 μm.

Further, after finite element simulation is carried out on an integrated interferometer model corresponding to the current supporting spring model to determine rotation angles of 4n groups of reflectors, the method specifically includes: an optical path difference of the integrated interferometer model is determined according to the rotation angles of the 4n groups of reflectors.

Further, an optical path difference of the integrated interferometer model is determined according to the rotation angles of the 4n groups of reflectors, which specifically includes: a first optical path difference of the integrated interferometer model is determined according to clockwise rotation angles of the 4n groups of reflectors; a second optical path difference of the integrated interferometer model is determined according to counterclockwise rotation angles of the 4n groups of reflectors; and the optical path difference of the integrated interferometer model is determined according to the first optical path difference and the second optical path difference.

Further, an optical path difference of the integrated interferometer model is determined according to the rotation angles of the 4n groups of reflectors, which specifically includes: the optical path difference of the integrated interferometer model is determined according to the clockwise rotation angles of the 4n groups of reflectors; alternatively, the optical path difference of the integrated interferometer model is determined according to the counterclockwise rotation angles of the 4n groups of reflectors.

Further, after the optical path difference of the integrated interferometer model is determined according to the rotation angles of the 4n groups of reflectors, the method specifically includes: determining whether the target number of the iterations is reached according to the optical path difference of the integrated interferometer model; determining that the target number of the iterations is reached when the optical path difference of the integrated interferometer model is greater than or equal to a preset optical path difference; and determining that the target number of the iterations is not reached when the optical path difference of the integrated interferometer model is less than the preset optical path difference.

### Embodiment 2

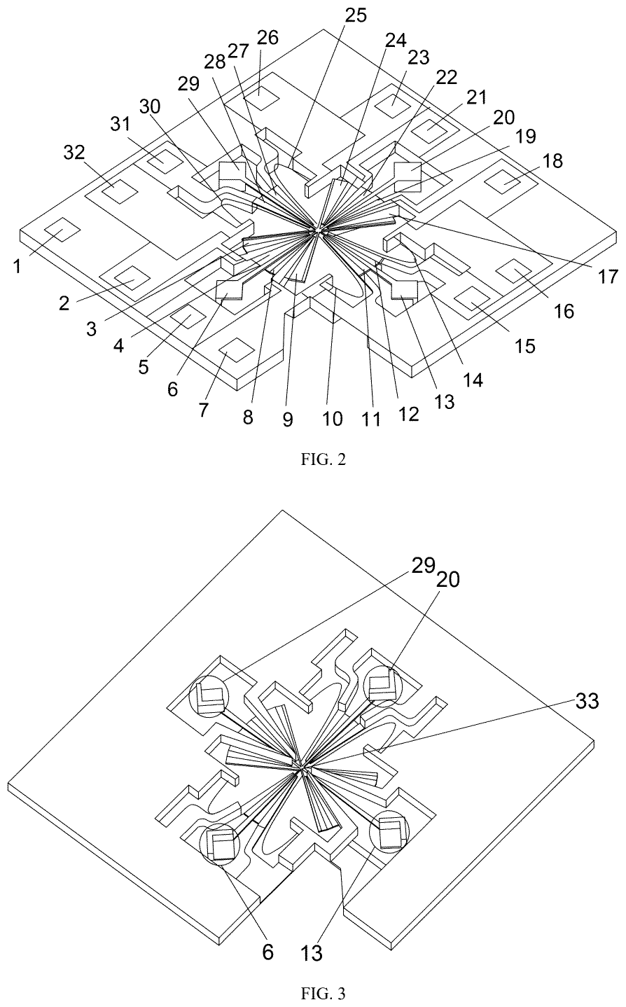

As shown in FIG. 2 to FIG. 3, the integrated interferometer device according to the present disclosure includes a component layer, a buried oxide layer and a substrate layer.

The component layer includes driving comb movable parts, driving comb fixing parts, sensing comb movable parts, sensing comb fixing parts, supporting spring structures and a fixing outer frame; the supporting spring structures are prepared by using the supporting spring model in Embodiment 1. The component layer has a bridge structure and is configured to be connected with the substrate layer.

The substrate layer includes a reflector structure and a balance weight structure;

The buried oxide layer is arranged between the component layer and the substrate layer for electrical insulation between the component layer and the substrate layer.

An end of each of multiple driving comb movable parts, an end of each of multiple sensing comb movable parts and an end of each of multiple supporting spring structures are all connected to the center of movable parts of the component layer 33.

Multiple driving comb fixing parts and the multiple driving comb movable parts are arranged in one-to-one correspondence. Multiple sensing comb fixing parts and the multiple sensing comb movable parts are arranged in one-to-one correspondence. Multiple driving comb fixing parts and the multiple sensing comb fixing parts are integrated with the fixing outer frame.

The reflector structure includes a first reflector structure 6 and a second reflector structure 13; the first reflector structure 6 is connected to the center of the movable parts of the component layer 33; the second reflector structure 13 is connected to the center of the movable parts of the component layer 33; the first reflector structure 6 and the second reflector structure 13 form an angle of 90 degrees and are both configured to reflect the received light; the reflector structure is integrated with the substrate layer; and the reflector structure is a corner cube. The reflector structure is designed as a corner cube structure, which improves the problem that the reflected light is not parallel to the incident light since the surface of the installed reflector is not vertical, solves the problem that the optical path deviation of the interferometer is large since it is difficult to install the reflector, and further improves the resolution of the infrared spectrometer. Moreover, the corner cube is a part of the substrate layer of the interferometer. The corner cube and the entire driving platform are integrated.

The balance weight structure includes a first balance weight structure 20 and a second balance weight structure 29; the first balance weight structure 20 and the second balance weight structure 29 are both connected with the center of the movable part of the component layer; the first balance weight structure 20 is configured to balance the first reflector structure 6; and the second balance weight structure 29 is configured to balance the second reflector structure 13.

An end of each of the multiple supporting spring structures is connected to the center of the movable parts of the component layer 33; an other end of each of the multiple supporting spring structures is connected to the fixing outer frame; the multiple supporting spring structures are configured to provide supporting moments for the multiple driving comb movable parts, the multiple sensing comb movable parts and the reflector structure. Specifically, there are four supporting spring structures, namely the first supporting spring structure 10, the second supporting spring structure 14, the third supporting spring structure 25 and the fourth supporting spring structure 30.

The driving comb movable parts and the driving comb fixing parts are configured to drive the reflector structure to move through a sensing driving electric signal.

The sensing comb movable parts and the sensing comb fixing parts are configured to detect capacitance signals used for calculating an optical path difference; and the capacitance signals are output from electrodes corresponding to the sensing comb fixing parts.

Further, a mirror surface of the reflector is prepared by depositing a reflecting layer material by using a hard mask.

Further, the sensing comb movable parts are arranged outside two pairs of driving combs at opposite positions.

Further, the driving comb movable parts, the driving comb fixing parts, the sensing comb movable parts and the sensing comb fixing parts are made by using a deep silicon etching process and by etching the substrate layer at back.

Further, the component layer further includes: an electrical interconnection system.

The electrical interconnection system is configured to be connected to an external circuit, and receive and output the driving electric signal transmitted by the external circuit.

Further, the component layer further includes driving electrodes, grounding electrodes and sensing electrodes.

The driving electrodes include one clockwise driving electrode and four counterclockwise driving electrodes, namely a first counterclockwise driving electrode 5, a second counterclockwise driving electrode 15, a third counterclockwise driving electrode 21 and a fourth counterclockwise driving electrode 31.

The clockwise driving electrode 1 is connected with the electrical interconnection system and the driving comb fixing parts, respectively, and is configured to receive the driving electric signal transmitted by the electrical interconnection system and transmit the driving electric signal to the driving comb fixing parts to drive the driving comb movable parts to move clockwise.

The four counterclockwise driving electrodes are connected with the electrical interconnection system and the driving comb fixing parts, and are configured to receive the driving electric signal transmitted by the electrical interconnection system and transmit the driving electric signal to the driving comb fixing parts to drive the driving comb movable parts to move counterclockwise.

The multiple grounding electrodes are connected with the electrical interconnection system and the ground, and are configured to provide multiple paths, so that the driving comb movable parts and the driving comb fixing parts keep electrostatic induction. There are three grounding electrodes, namely the first grounding electrode 16, the second grounding electrode 26 and the third grounding electrode 32.

The multiple sensing electrodes are connected with the electrical interconnection system and the sensing comb fixing parts, and are configured to extract the capacitance signals. There are four sensing electrodes, namely the first sensing electrode 2, the second sensing electrode 7, the third sensing electrode 18 and the fourth sensing electrode 23.

Further, the driving electrodes, the grounding electrodes and the sensing electrodes are deposited on the component layer by a lift-off process.

Further, a beam splitter structure 34 is further included.

The beam splitter structure 34 is arranged between the first reflector structure 6 and the second reflector structure 13. The beam splitter structure 34 forms an angle of 45 degrees with the first reflector structure 6 and the second reflector structure 13, respectively.

Further, the component layer is made of silicon; the buried oxygen layer is made of silicon oxide; and the substrate layer is made of silicon.

The integrated interferometer device provided by the present disclosure uses a rotating wishbone interferometer. Compared with the traditional Michelson interferometer, the optical path difference of the rotating wishbone interferometer is twice that of the Michelson interferometer, which is beneficial to improving the resolution of the spectrum.

The working principle and the process of the Fourier infrared spectrometer including the integrated interferometer device 37 in Embodiment 2 are described in detail hereinafter.

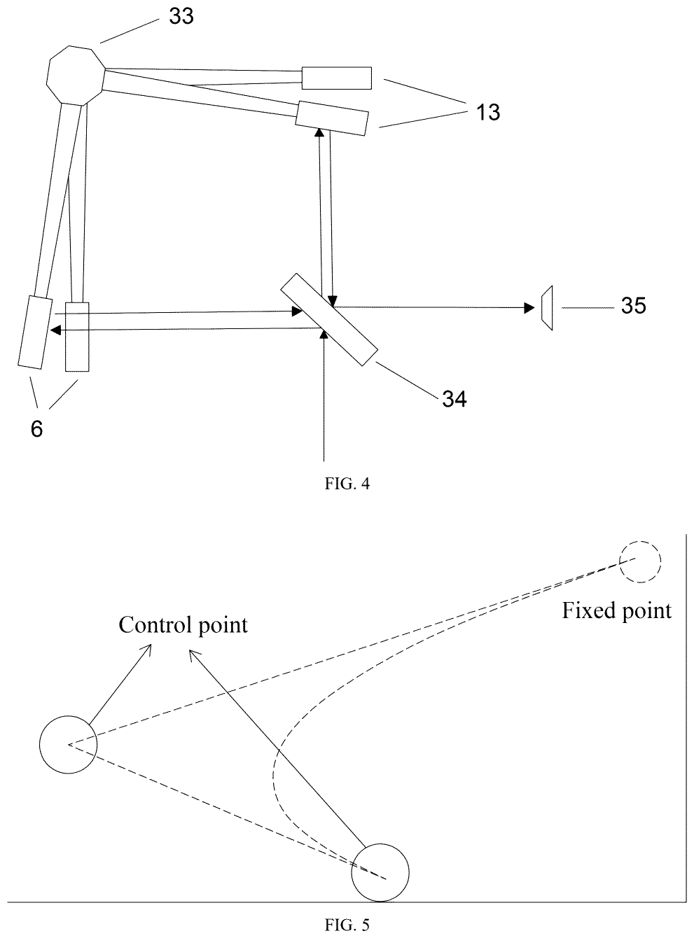

The working principle of the Fourier infrared spectrometer is classified into two parts: a driving principle and an interference principle. The driving principle is to apply the voltage to the driving electrodes of the driving comb fixing parts on the outer frame of the interferometer, and uses an electrostatic force to drive the interferometer driving platform to carry out in-plane rotation motion. The interference principle mainly uses the coherent light of continuous light, and obtains the spectrogram by performing the Fourier transform of the coherent light for calculation. The interferometer is the core of the entire spectrometer, which is an important assembly to generate the coherent light by using the optical path difference between the reflected light and the transmitted light. As shown in FIG. 4, the infrared light source 36 emits the infrared light to the beam splitter structure 34 with an inclination angle of 45 degrees. The infrared light is divided into the reflected light and the transmitted light through the beam splitter structure 34, which are incident perpendicular to the first reflector structure 6 and the second reflector structure 13 of the interferometer, respectively, and then are reflected back to the beam splitter structure 34 by the first reflector structure 6 and the second reflector structure 13. Initially, the interferometer driving platform is stationary, and the optical paths of the reflected light and the transmitted light are equal to each other, so that there is no interference. When the interferometer driving platform is driven, the first reflector structure 6 and the second reflector structure 13 carry out in-plane rotation motion with the interferometer driving platform. There is an optical path difference Δx between the optical paths along which the reflected light and the transmitted light are incident to the first reflector structure 6 and the second reflector structure 13 and are reflected back to the beam splitter structure 34, so that the two beams reflected back to the beam splitter structure 34 by the first reflector structure 6 and the second reflector structure 13 will interfere to form the interference light. The interference light information can be read by using the infrared detector 35, so as to obtain the coherence map. Finally, the spectral information is acquired by calculating the coherence map through the Fourier transform.

A high resolution is an important parameter to evaluate the performance of the Fourier infrared spectrometer. The resolution Δv=1/Δx, where Δx is the optical path difference of the spectrometer. A high-resolution spectrometer requires a large optical path difference, which requires that the movable parts of the interferometer (including the driving comb movable parts, the sensing comb movable parts, the supporting spring structures, the first reflector structure 6, the second reflector structure 13, the first balance weight structure 20 and the second balance weight structure 29) can achieve a large angle. The supporting spring structures supporting the internal movable parts is the main factor limiting the large angle of the movable parts. The second-order Bezier curve is used as the supporting spring model, and the optimized supporting spring model is created iteratively through the genetic algorithm. Each iteration of springs can achieve a larger rotation angle under the same driving voltage than the previous iteration of springs, and the actual supporting spring structure is prepared according to the supporting spring model after six iterations.

The second-order Bezier curve is used as the supporting spring model, and the optimized supporting spring model is created iteratively through the genetic algorithm. The specific process is as follows.

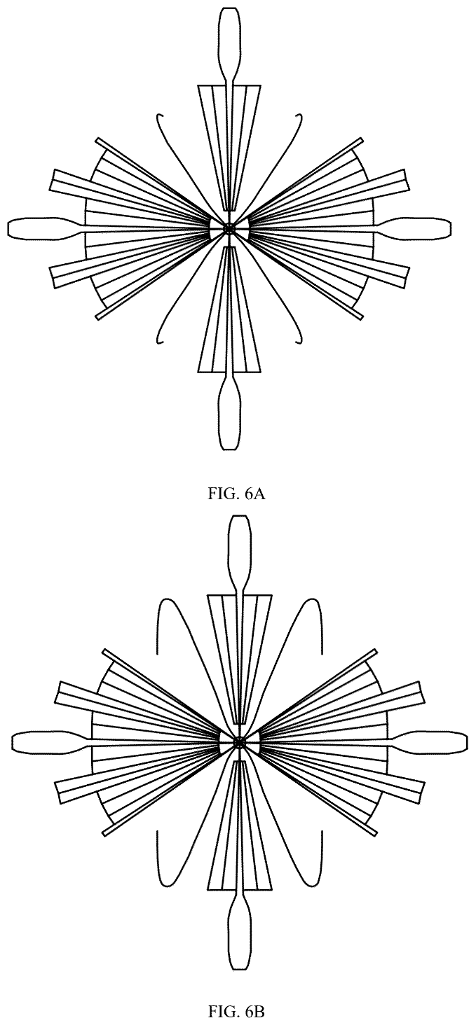

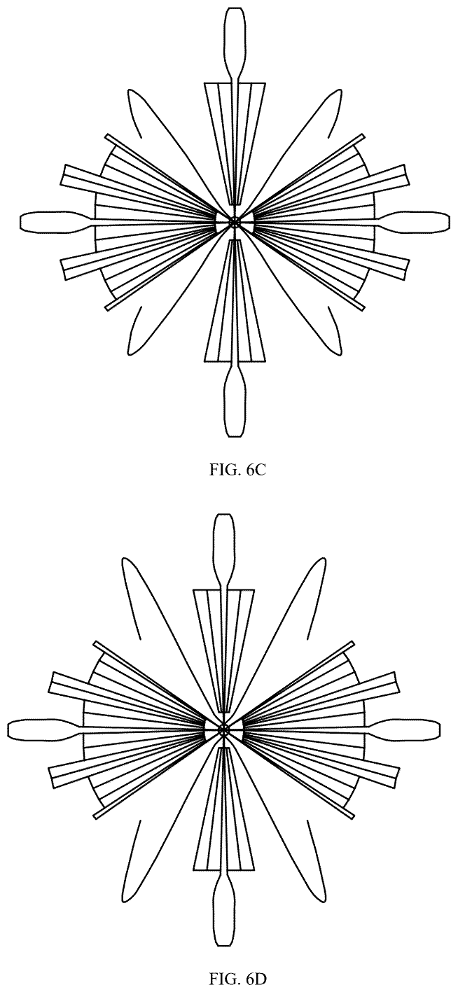

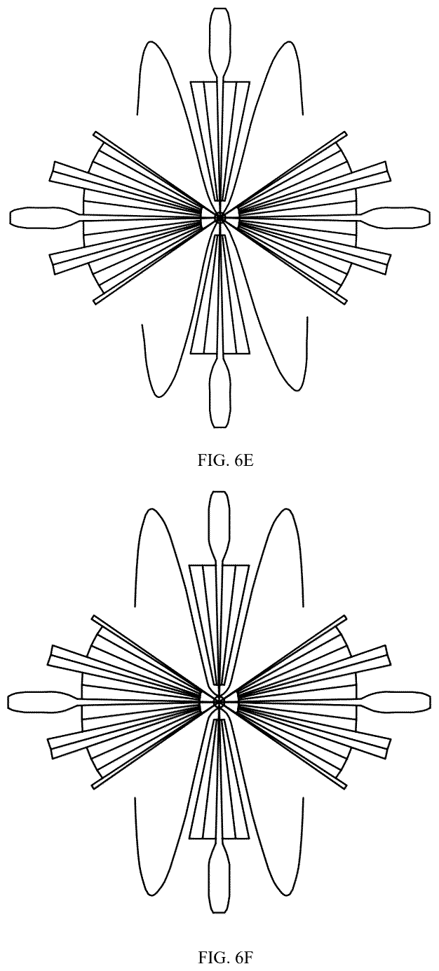

The second-order Bezier curve spring is determined by three control points, as shown in FIG. 5, in which the coordinate of the control point connected with the movable part have been determined. Therefore, a new supporting spring model can be created only by constantly changing the coordinates of the other two control points. Initially, 40 groups of control point coordinate sequences are randomly created in the mathematical modeling software installed in the computer, and each group of control point coordinate sequences includes 4 numbers (consisting of the abscissa and the ordinate of two control points in sequence). Using the interconnection interface between mathematical modeling and finite element simulation software, 40 interferometer models of different supporting spring models are subject to finite element simulation in the finite element simulation software. The rotational displacements of 40 groups of interferometer model movable parts are obtained by simulating electrostatic driving at the same voltage. The finite element simulation software sends the simulation data back to the mathematical modeling software through the interface, and the computer uses the mathematical modeling software to complete the construction of the control point sequences of the new-generation supporting spring model. According to the decreasing order, the top 20 groups of supporting spring models with generated displacement are selected as the new-generation springs to inherit the previous-generation excellent parent sequences. Thereafter, the control point coordinate sequences of the 20 groups of supporting spring models are cross-combined to obtain 10 groups of new control point coordinate sequences, and the crossing is limited to the crossing between the corresponding abscissa and ordinate (for example, x1, y1, x2, y2 and x1′, y1′, x2′, y2′, that is, two groups of control point coordinate sequences, can be crossed as x1′, y1, x2, y2′). In addition, the abscissa and the ordinate in the control point coordinate sequences of the above 20 groups of excellent parents are floated in a small range, and 10 groups of new control point coordinate sequences are generated by mutation (due to the limited space of the supporting spring structure, the range of fluctuation of control points needs to be additionally defined), wherein floating in the small range refers to floating in the range of 0 μm-20 μm. Therefore, the 40 groups of the second-generation control point coordinate sequences are obtained from the first-generation parent sequences through screening, crossing and mutation, and the new-generation control point coordinate sequences are sent into the finite element simulation software for rotational displacement simulation. The supporting spring model consisted of the new-generation control point sequences allows the interferometer to obtain a larger optical path difference than the previous-generation supporting spring model. After cycling through the interconnection interface of mathematical modeling and finite element simulation software for many iterations, the maximum optical path difference obtained by the created supporting spring model tends to be stable, as shown in FIG. 6A to FIG. 6F, which is the optimization process of the supporting spring model of the integrated interferometer. In the present disclosure, the supporting spring model after six iterations is selected to prepare the actual supporting spring structure.

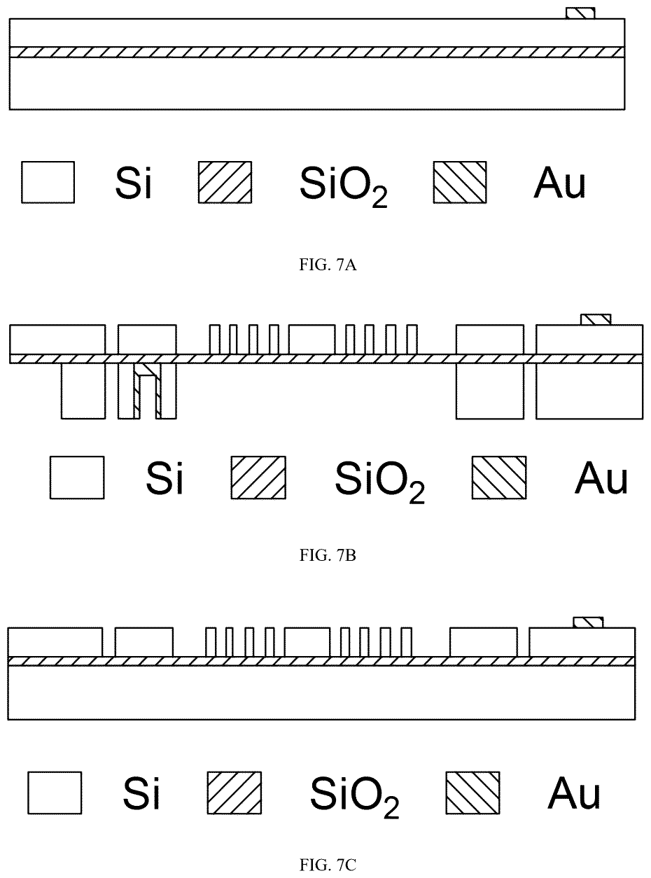

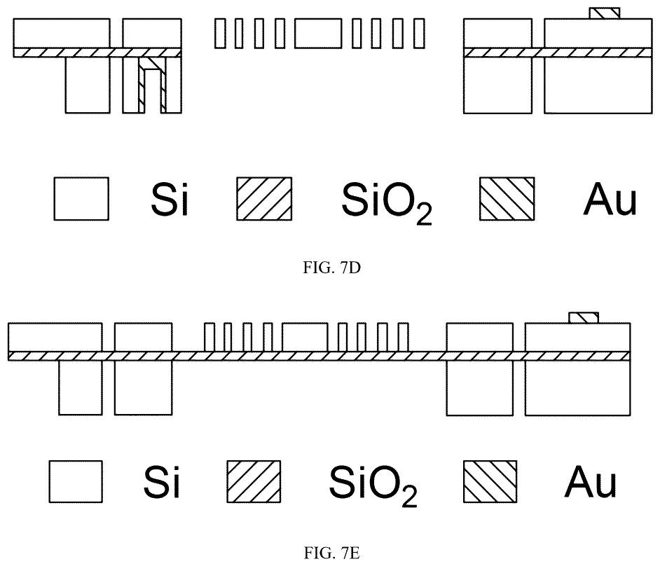

The placement of the reflector is an important factor to determine the optical path deviation of the interferometer. In the present disclosure, the reflector and the interferometer driving platform are integrally processed by using a Silicon-On-Insulator (SOI), which abandons the unstable manual micro-assembly. As shown in FIG. 7A to FIG. 7E, the processing technology of the interferometer is shown. The driving electrodes, the grounding electrodes and the sensing electrodes are deposited on the SOI by the lift-off process. The deep silicon etching process is used to make the component layer form a comb structure. The comb structure is suspended by etching the substrate layer at back. A pair of reflector structures and a pair of balance weight structures are formed on the four arms of the driving platform, respectively. A hard mask is used to deposit reflecting layer material on the surface of the reflector, and finally, the oxide layer is etched to complete the processing of the interferometer. The entire integrated interferometer can be processed only through the simple micro-nano processing technology without manual micro-assembly of the reflectors. The processed reflectors are ensured to be highly perpendicular to the interferometer driving platform, so that the incident light and the reflected light of the two reflector structures are highly parallel to each other, which avoids the problem that the optical path deviation is large due to installation errors. In order to ensure the robustness of the entire structure, the component layer of the integrated interferometer device has a concave design, and the component layer is integrally connected through a bridge structure.

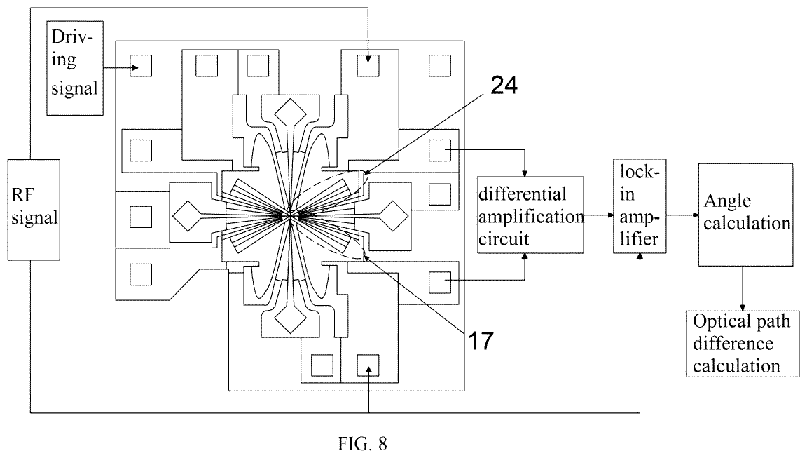

In addition, in order to acquire the accurate rotation angle of the interferometer driving platform, two pairs of differential angle sensors are added to accurately calculate the optical path difference between the reflected light and the transmitted light by using the consistency of the rotation angles of the driving comb movable parts. The details are as follows. As shown in FIG. 8, when driving voltages are applied to the driving comb fixing parts corresponding to a second part of a first driving comb movable part 8, a second part of a second driving comb movable part 12, a second part of a third driving comb movable part 22, and a second part of a fourth driving comb movable part 28, the second part of the first driving comb movable part 8, the second part of the second driving comb movable part 12, the second part of the third driving comb movable part 22, and the second part of the fourth driving comb movable part 28 drive the movable parts to move clockwise. At this time, the first part of the second sensing comb movable part 17 and the second part of the second sensing comb movable part 24 rotate clockwise synchronously, so that the capacitance of the capacitors of the first part of the second sensing comb movable part 17 and the second part of the second sensing comb movable part 24 changes. The first part of the second sensing comb movable part 17 approaches the corresponding sensing comb fixing part, and the capacitance of the capacitor of the first part of the second sensing comb movable part 17 increases by ΔC. The second part of the second sensing comb movable part 24 moves away from the corresponding sensing comb fixing part, and the capacitance of the capacitor of the second part of the second sensing comb movable part 24 decreases by ΔC. Therefore, the first part of the second sensing comb movable part 17 and the second part of the second sensing comb movable part 24 can be used as a pair of differential angle sensors. By detecting the capacitance difference between the first part of the second sensing comb movable part 17 and the second part of the second sensing comb movable part 24, the counterclockwise rotation angle of the movable parts of the integrated interferometer can be calculated. RF signals are applied to the grounding electrodes. Currents i₁ and i₂ can be detected at the output ends of the first part of the second sensing comb movable part 17 and the second part of the second sensing comb movable part 24, respectively. The current signals are amplified and converted into voltage signals V₁ and V₂ by the sensing circuit. The voltage signals are subtracted and then amplified proportionally, and then the amplified signals are transmitted to the lock-in amplifier to obtain voltage signals without interference (RF signals are also transmitted to the lock-in amplifier as reference signals). Because the voltage signals are proportional to the angular displacement, the moving angle of the movable parts of the integrated interferometer can be obtained, and the optical path difference of the integrated interferometer can be calculated.

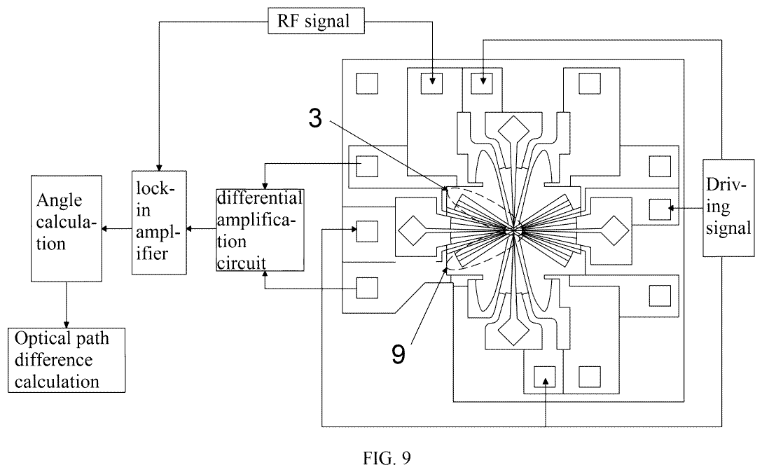

Similarly, when the movable part of the integrated interferometer moves counterclockwise, as shown in FIG. 9, when driving voltages are applied to the driving comb movable parts corresponding to a first part of a first driving comb movable part 4, a first part of a second driving comb movable part 11, a first part of a third driving comb movable part 19, and a first part of a fourth driving comb movable part 27, respectively, the first part of the first driving comb movable part 4, the first part of the second driving comb movable part 11, the first part of the third driving comb movable part 19, and the first part of the fourth driving comb movable part 27 drive the movable parts to move counterclockwise. At this time, the first part of the first sensing comb movable part 3 and the second part of the first sensing comb movable part 9 rotate counterclockwise synchronously, so that the capacitance of the capacitors of the first part of the first sensing comb movable part 3 and the second part of the first sensing comb movable part 9 changes. The second part of the first sensing comb movable part 9 approaches the corresponding sensing comb fixing part, and the capacitance of the capacitor of the second part of the first sensing comb movable part 9 increases. The first part of the first sensing comb movable part 3 moves away from the corresponding sensing comb fixing part, and the capacitance of the capacitor of the first part of the first sensing comb movable part 3 decreases. Therefore, the first part of the first sensing comb movable part 3 and the second part of the first sensing comb movable part 9 can be used as a pair of differential angle sensors. By detecting the capacitance difference between the first part of the first sensing comb movable part 3 and the second part of the first sensing comb movable part 9, the counterclockwise rotation angle of the movable parts of the integrated interferometer can be calculated. RF signals are applied to the grounding electrodes. Currents i₃ and i₄ can be detected at the output ends of the first part of the first sensing comb movable part 3 and the second part of the first sensing comb movable part 9, respectively. The current signals are amplified and converted into voltage signals by the sensing circuit. The voltage signals are subtracted and then amplified proportionally, and then the amplified signals are transmitted to the lock-in amplifier to obtain voltage signals without interference (RF signals are also transmitted to the lock-in amplifier as reference signals). Because the voltage signals are proportional to the angular displacement, the moving angle of the movable parts of the integrated interferometer can be obtained, and the optical path difference of the integrated interferometer can be calculated.

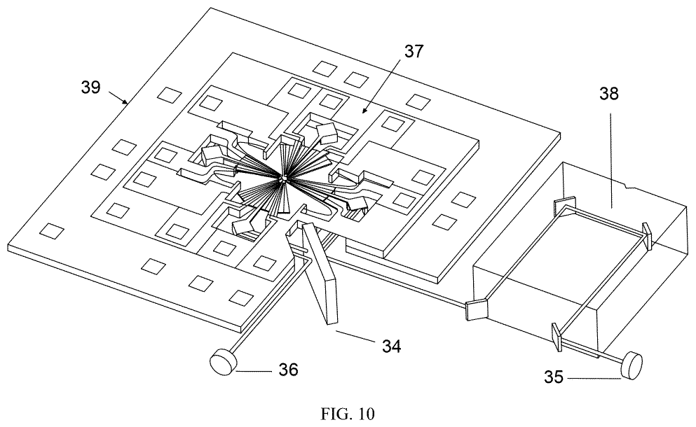

Further, as shown in FIG. 10, the detection process of gas detection by Fourier infrared spectrometer is as follows. The entire Fourier infrared spectrometer includes an infrared light source 36, an integrated interferometer device 37, a beam splitter structure 34, a gas chamber 38 and an infrared detector 35. The infrared light is divided into transmitted light and reflected light through the beam splitter structure 34, which are incident into the two reflectors of the integrated interferometer and reflected back to the beam splitter structure, respectively. A driving voltage is applied to the driving comb fixing parts of the integrated interferometer device 37 through the PCB 39, and the reflector structure rotates with the interferometer driving platform. The transmitted light interferes with the reflected light at the beam splitter structure 34. The interference light is guided into the gas chamber 38. The intensity of the interference light at the outlet of the gas chamber 38 is detected by the infrared detector 35. When the driving voltage is increased to the maximum, the rotation angle of the interferometer driving platform of the integrated interferometer device 37 is maximum, and the maximum optical path difference is formed between the transmitted light and the reflected light. The background coherence map without gas passing through is obtained by the infrared detector 35 and the angle sensor, and the background spectrum map is obtained by calculating the background coherence map through the Fourier transform. The information of the light intensity of the detector is also connected to the computer. The information about the optical path difference and the intensity of the interference light are collected at the same sampling frequency, and the interferogram is drawn on an upper computer. The gas to be measured is introduced into the gas chamber 38. The same driving voltage is applied to reach the maximum optical path difference. The greater the maximum optical path difference, the more spectral information is scanned, and the higher the resolution of the infrared spectrometer. Different gases will absorb interference light with different wavelengths. The interference light is continuously reflected in the gas chamber 38 so that the interference light is fully absorbed by the gas to be measured. The absorbed interference light will be detected by the infrared detector 35 at the outlet of the gas chamber 38. The coherence map after passing through the gas to be measured is obtained and converted into a sample spectrogram through the Fourier transform. The background spectrum is subtracted from the sample spectrogram to obtain the transmission spectrum. By being compared with the database spectrum, the composition and corresponding concentration of the gas to be measured can be detected, so as to detect the composition and the corresponding concentration of gas. Specifically, the spectrogram obtained through the Fourier transform in the mathematical modeling software according to the interferogram is compared with the standard spectrogram in the library, and the composition and the concentration of gas are detected according to the peak value and the distribution of the light intensity under the corresponding wave number of the spectrogram.

According to the present disclosure, the optimized supporting spring model is used to prepare the supporting spring structure of the interferometer, so that the optical path difference is increased. The integrated processing of the reflector and the interferometer driving platform through the MEMS technology not only solves the problem that it is difficult to install the reflector, but also avoids the problem that the optical path deviation is large due to the micro-assembly of the reflector. The optical path difference is increased, the resolution of the infrared spectrometer is improved, the accuracy of spectral information acquired by the infrared spectrometer is further improved, and finally the detection precision of the composition and the corresponding concentration of gas is improved.

The technical features of the above embodiments can be combined at will. In order to make the description concise, not all possible combinations of the technical features in the above embodiments are described. However, as long as there is no contradiction in the combinations of these technical features, the combinations should be considered as the scope recorded in this specification.

In the present disclosure, specific examples are applied to illustrate the principle and embodiments of the present disclosure, and the explanations of the above embodiments are only used to help understand the method and the core idea of the present disclosure. At the same time, according to the idea of the present disclosure, there will be some changes in the detailed description and application scope for those skilled in the art. To sum up, the contents of the specification should not be construed as limiting the present disclosure.

What is claimed is:

1. A method for preparing a supporting spring model, comprising:
determining a first control point coordinate of a second-order Bezier curve for simulating a supporting spring model based on the second-order Bezier curve in a mathematical modeling software installed in a computer;
randomly creating 4n groups of initial control point coordinate sequences of the second-order Bezier curve for simulating the supporting spring model in a modelable area of the supporting spring model based on the second-order Bezier curve; wherein the initial control point coordinate sequences each comprise a second control point abscissa of the second-order Bezier curve, a second control point ordinate of the second-order Bezier curve, a third control point abscissa of the second-order Bezier curve and a third control point ordinate of the second-order Bezier curve; 4n is a number of the initial control point coordinate sequences, and n is a positive number greater than or equal to 1;
iterating the 4n groups of initial control point coordinate sequences by using a genetic algorithm, and creating 4n groups of target control point coordinate sequences when a target number of iterations is reached;
determining the supporting spring model according to the first control point coordinate and the 4n groups of target control point coordinate sequences;
preparing a supporting spring structure in an integrated interferometer device according to the supporting spring model.

2. The method for preparing the supporting spring model according to claim 1, wherein iterating the 4n groups of initial control point coordinate sequences by using a genetic algorithm, and creating 4n groups of target control point coordinate sequences when a target number of iterations is reached, specifically comprises:
iterating the 4n groups of initial control point coordinate sequences by using the genetic algorithm, and creating the 4n groups of target control point coordinate sequences when the target number of the iterations is reached;
each of the iterations comprises:
determining a current supporting spring model according to the first control point coordinate and 4n groups of current control point coordinate sequences;
carrying out finite element simulation on an integrated interferometer model corresponding to the current supporting spring model to determine rotation angles of 4n groups of reflectors; wherein the rotation angles of the reflectors are rotation angles of reflectors of the integrated interferometer model corresponding to the current supporting spring; the integrated interferometer model is configured to prepare the integrated interferometer device;
determining 4n groups of control point coordinate sequences for next iteration based on the rotation angles of the 4n groups of reflectors.

3. The method for preparing the supporting spring model according to claim 2, wherein subsequent to carrying out finite element simulation on an integrated interferometer model corresponding to the current supporting spring model to determine rotation angles of 4n groups of reflectors, the method specifically comprises:
determining an optical path difference of the integrated interferometer model according to the rotation angles of the 4n groups of reflectors.

4. The method for preparing the supporting spring model according to claim 3, wherein determining an optical path difference of the integrated interferometer model according to the rotation angles of the 4n groups of reflectors specifically comprises:
determining a first optical path difference of the integrated interferometer model according to clockwise rotation angles of the 4n groups of reflectors;
determining a second optical path difference of the integrated interferometer model according to counterclockwise rotation angles of the 4n groups of reflectors;
determining the optical path difference of the integrated interferometer model according to the first optical path difference and the second optical path difference.

5. The method for preparing the supporting spring model according to claim 3, wherein subsequent to determining an optical path difference of the integrated interferometer model according to the rotation angles of the 4n groups of reflectors, the method specifically comprises:
determining whether the target number of the iterations is reached according to the optical path difference of the integrated interferometer model;
determining that the target number of the iterations is reached when the optical path difference of the integrated interferometer model is greater than or equal to a preset optical path difference;
determining that the target number of the iterations is not reached when the optical path difference of the integrated interferometer model is less than the preset optical path difference.

6. An integrated interferometer device, comprising a component layer, a buried oxide layer and a substrate layer;
wherein the component layer comprises a plurality of driving comb movable parts, a plurality of driving comb fixing parts, a plurality of sensing comb movable parts, a plurality of sensing comb fixing parts, a plurality of supporting spring structures and a fixing outer frame; each of the supporting spring structures is prepared by the method for preparing the supporting spring model according to claim 1; the component layer has a bridge structure; the component layer is configured to be connected with the substrate layer;
the substrate layer comprises a reflector structure and a balance weight structure;
the buried oxide layer is arranged between the component layer and the substrate layer for electrical insulation between the component layer and the substrate layer;
an end of each of the plurality of driving comb movable parts, an end of each of the plurality of sensing comb movable parts and an end of each of the plurality of supporting spring structures are all connected to a center of movable parts of the component layer;
the plurality of driving comb fixing parts and the plurality of driving comb movable parts are arranged in one-to-one correspondence; the plurality of sensing comb fixing parts and the plurality of sensing comb movable parts are arranged in one-to-one correspondence; the plurality of driving comb fixing parts and the plurality of sensing comb fixing parts are integrated with the fixing outer frame;
the reflector structure comprises a first reflector structure and a second reflector structure; the first reflector structure is connected to the center of the movable parts of the component layer; the second reflector structure is connected to the center of the movable parts of the component layer; the first reflector structure and the second reflector structure form an angle of 90 degrees and are both configured to reflect received light; the reflector structure is integrated with the substrate layer; and the reflector structure is a corner cube;
the balance weight structure comprises a first balance weight structure and a second balance weight structure; the first balance weight structure and the second balance weight structure are both connected with the center of the movable parts of the component layer; the first balance weight structure is configured to balance the first reflector structure; the second balance weight structure is configured to balance the second reflector structure;
an end of each of the plurality of supporting spring structures is connected to the center of the movable parts of the component layer; an other end of each of the plurality of supporting spring structures is connected to the fixing outer frame; the plurality of supporting spring structures are configured to provide supporting moments for the plurality of driving comb movable parts, the plurality of sensing comb movable parts and the reflector structure;
the driving comb movable parts and the driving comb fixing parts are configured to drive the reflector structure to move through a sensing driving electric signal;
the sensing comb movable parts and the sensing comb fixing parts are configured to detect capacitance signals used for calculating an optical path difference; and the capacitance signals are output from electrodes corresponding to the sensing comb fixing parts.

7. The integrated interferometer device according to claim 6, wherein a mirror surface of the reflector structure is prepared by depositing a reflecting layer material by using a hard mask.

8. The integrated interferometer device according to claim 6, wherein the driving comb movable parts, the driving comb fixing parts, the sensing comb movable parts and the sensing comb fixing parts are made by using a deep silicon etching process and by etching the substrate layer at back.

9. The integrated interferometer device according to claim 6, wherein the component layer further comprises: an electrical interconnection system;
the electrical interconnection system is configured to be connected to an external circuit, and receive and output a driving electric signal transmitted by the external circuit.

10. The integrated interferometer device according to claim 9, wherein the component layer further comprises driving electrodes, a plurality of grounding electrodes and a plurality of sensing electrodes;
the driving electrodes comprise one clockwise driving electrode and four counterclockwise driving electrodes;
the clockwise driving electrode is connected with the electrical interconnection system and the driving comb fixing parts, respectively, and is configured to receive the driving electric signal transmitted by the electrical interconnection system and transmit the driving electric signal to the driving comb fixing parts to drive the driving comb movable parts to move clockwise;
the four counterclockwise driving electrodes are connected with the electrical interconnection system and the driving comb fixing parts, and are configured to receive the driving electric signal transmitted by the electrical interconnection system and transmit the driving electric signal to the driving comb fixing parts to drive the driving comb movable parts to move counterclockwise;
the plurality of grounding electrodes are connected with the electrical interconnection system and the ground, and are configured to provide a plurality of paths to enable the driving comb movable parts and the driving comb fixing parts to be kept electrostatic induction;
the plurality of sensing electrodes are connected with the electrical interconnection system and the sensing comb fixing parts, and are configured to extract the capacitance signals.

11. The integrated interferometer device according to claim 6, wherein iterating the 4n groups of initial control point coordinate sequences by using a genetic algorithm, and creating 4n groups of target control point coordinate sequences when a target number of iterations is reached, specifically comprises:
iterating the 4n groups of initial control point coordinate sequences by using the genetic algorithm, and creating the 4n groups of target control point coordinate sequences when the target number of the iterations is reached;
each of the iterations comprises:
determining a current supporting spring model according to the first control point coordinate and 4n groups of current control point coordinate sequences;
carrying out finite element simulation on an integrated interferometer model corresponding to the current supporting spring model to determine rotation angles of 4n groups of reflectors; wherein the rotation angles of the reflectors are rotation angles of reflectors of the integrated interferometer model corresponding to the current supporting spring; the integrated interferometer model is configured to prepare the integrated interferometer device;
determining 4n groups of control point coordinate sequences for next iteration based on the rotation angles of the 4n groups of reflectors.

12. The integrated interferometer device according to claim 11, wherein subsequent to carrying out finite element simulation on an integrated interferometer model corresponding to the current supporting spring model to determine rotation angles of 4n groups of reflectors, the method specifically comprises:
determining an optical path difference of the integrated interferometer model according to the rotation angles of the 4n groups of reflectors.

13. The integrated interferometer device according to claim 12, wherein determining an optical path difference of the integrated interferometer model according to the rotation angles of the 4n groups of reflectors specifically comprises:
determining a first optical path difference of the integrated interferometer model according to clockwise rotation angles of the 4n groups of reflectors;
determining a second optical path difference of the integrated interferometer model according to counterclockwise rotation angles of the 4n groups of reflectors;
determining the optical path difference of the integrated interferometer model according to the first optical path difference and the second optical path difference.

14. The integrated interferometer device according to claim 12, wherein subsequent to determining an optical path difference of the integrated interferometer model according to the rotation angles of the 4n groups of reflectors, the method specifically comprises:
determining whether the target number of the iterations is reached according to the optical path difference of the integrated interferometer model;
determining that the target number of the iterations is reached when the optical path difference of the integrated interferometer model is greater than or equal to a preset optical path difference;
determining that the target number of the iterations is not reached when the optical path difference of the integrated interferometer model is less than the preset optical path difference.
The integrated interferometer device according to claim 6, wherein a mirror surface of the reflector structure is prepared by depositing a reflecting layer material by using a hard mask.

15. The integrated interferometer device according to claim 11, wherein a mirror surface of the reflector structure is prepared by depositing a reflecting layer material by using a hard mask.

16. The integrated interferometer device according to claim 11, wherein the driving comb movable parts, the driving comb fixing parts, the sensing comb movable parts and the sensing comb fixing parts are made by using a deep silicon etching process and by etching the substrate layer at back.

17. The integrated interferometer device according to claim 11, wherein the component layer further comprises: an electrical interconnection system;
the electrical interconnection system is configured to be connected to an external circuit, and receive and output a driving electric signal transmitted by the external circuit.

18. The integrated interferometer device according to claim 17, wherein the component layer further comprises driving electrodes, a plurality of grounding electrodes and a plurality of sensing electrodes;
the driving electrodes comprise one clockwise driving electrode and four counterclockwise driving electrodes;
the clockwise driving electrode is connected with the electrical interconnection system and the driving comb fixing parts, respectively, and is configured to receive the driving electric signal transmitted by the electrical interconnection system and transmit the driving electric signal to the driving comb fixing parts to drive the driving comb movable parts to move clockwise;
the four counterclockwise driving electrodes are connected with the electrical interconnection system and the driving comb fixing parts, and are configured to receive the driving electric signal transmitted by the electrical interconnection system and transmit the driving electric signal to the driving comb fixing parts to drive the driving comb movable parts to move counterclockwise;
the plurality of grounding electrodes are connected with the electrical interconnection system and the ground, and are configured to provide a plurality of paths to enable the driving comb movable parts and the driving comb fixing parts to be kept electrostatic induction;
the plurality of sensing electrodes are connected with the electrical interconnection system and the sensing comb fixing parts, and are configured to extract the capacitance signals.

19. The integrated interferometer device according to claim 12, wherein a mirror surface of the reflector structure is prepared by depositing a reflecting layer material by using a hard mask.

20. The integrated interferometer device according to claim 12, wherein the driving comb movable parts, the driving comb fixing parts, the sensing comb movable parts and the sensing comb fixing parts are made by using a deep silicon etching process and by etching the substrate layer at back.
